(19) United States
(12) Patent Application Publication
(10) Pub. No.: US 2010/0090435 A1
(43) Pub. Date: Apr. 15, 2010

(54) Arm and Leg Powered Vehicle

(76) Inventor: Boris Tarasov, Sorrento (AU)

Correspondence Address: EDELL, SHAPIRO & FINNAN, LLC, 1901 RESEARCH BOULEVARD, SUITE 400, ROCKVILLE, MD, 20850, US

(21) Appl. No.: 12/641,556

(22) Filed: Dec. 18, 2009

Related U.S. Application Data
(63) Continuation of application No. 12/026,013, filed on Feb. 5, 2008.
Application No. 12/026,013 is a continuation of application No. PCT/AU2006/001127, filed on Aug. 9, 2006.

(30) Foreign Application Priority Data
Aug. 9, 2005 (AU) 2005904271

(51) Int. Cl. B62M 1/00

(52) U.S. Cl. 280/234

(57) ABSTRACT

An arm and leg powered vehicle includes a chassis mounted on a plurality of wheels, at least one of said wheels being a drive wheel wherein rotation of the drive wheel propels the vehicle forward, a seat mounted on the chassis for a rider to sit on, the seat being constrained against longitudinal movement relative to the chassis, a handlebar operatively connected to a steering rod whereby axial rotation of the handlebar generates a turn on at least one of said wheels, the handlebar including a handle holder arranged to move in a linear reciprocating manner relative to the steering rod, a foot pedal housing arranged to move in a linear reciprocating manner relative to a rail fixedly connected to the chassis, and, a power transmission system for receiving power from the arms of the rider in response to the application of a pulling force to the handlebar and from the legs of the rider in response to the application of the pushing force to the foot pedal housing and for transmission of the received power to the drive wheel. When the arms and legs of the rider are used independently, the power transmission system is configured to receive and transmit power from the arms or the legs of the rider, and when the arms and legs of the rider are used simultaneously, the power transmission system is configured to receive and transmit the sum of the power from the arms and the legs of the rider.

### CROSS REFERENCE TO RELATED APPLICATIONS

This application is a continuation of U.S. patent application Ser. No. 12/026,013, filed Feb. 5, 2008, and titled “An Arm and Leg Powered Vehicle,” which is a continuation of PCT/AU02006/001127, filed Aug. 9, 2006, and to Australian Application No. AU 2005904271, filed on Aug. 9, 2005. The entire contents of these applications are hereby incorporated by reference in their entireties.

### FIELD

The present invention relates to an arm and leg powered vehicle, and more particularly to a vehicle powered using a linear reciprocating rowing motion. The arm and leg powered vehicle may be used for outdoors for transportation or indoors as a piece of exercise equipment.

### BACKGROUND

Bicycles and tricycles are known in the prior art and are generally used as a means for transport or for exercise. Being able to ride at record speeds is a major driver behind improvements to any kind of vehicle, including vehicles driven using human power, especially bicycles. Traditional bicycles rely solely on the use of the rider's legs to provide power with the result that the exercise provides little benefit to other muscles in the body. The sport of rowing, however, calls into action nearly all of the muscles of the body, most particularly the arm, leg and back muscles. The drawback of rowing is that the rower is obliged to find a suitable stretch of water to enjoy the benefits of this type of exercise outdoors.

Various types of arm and leg powered or “rowing” vehicles are known in the prior art. Such vehicles utilize the power of the rider's arms and back to supplement the power provided by the legs with many being based on a sculling or rowing motion. As a result it could be expected that a cycle powered by arm and leg motion would allow greater speeds to be achieved and maintained.

Some of the prior art arm and leg powered vehicles use sliding seats (see WO 03/016126, SU 1129116, U.S. Pat. No. 6,708,996, WO 01/03996) to simulate the action of competitive sculling which is the most efficient kind of rowing. These designs do not however take full advantage of available power from the legs of the rider. Depending on the athleticism of the rider, their legs should be able to deliver one and a half to two times the power that can be delivered by their back and arms whilst rowing. When a sliding seat arrangement is used, the force applied to the pedals of the row-bike by the legs is equal to the force applied to a handle by the arms in the direction of their motion. As a result, the maximum usable force developed by legs, which are the strongest parts of the human body, is determined by the strength of back and arms, which are weaker. Hence, vehicles using sliding seats cannot provide the efficient realization of the leg muscle capability.

Other existing designs utilise a fixed seat plus back rest arrangement which allows for a more efficient realization of the capability of all muscle groups. Using a fixed seat plus back rest arrangement, the force applied to the pedals of the row-bike by the legs is equal to the sum of the force applied to a handle by the arms and the additional force delivered by the legs of the rider between the pedal and the back rest. A better arrangement that utilises the capacity of all muscle groups is theoretically achievable using a fixed seat plus back rest plus sliding pedal arrangement that allows simultaneous application of the maximum forces developed by legs, the back and the arms.

There are several prior art rowing vehicles use a “fixed seat+back rest+sliding pedal” arrangement, for example U.S. Pat. No. 4,508,358, U.S. Pat. No. 4,928,986, RU2201785, and FR2455540. However these rowing vehicles fail to deliver the expected speed advantage due to inefficiencies in the design of the power transmission system that drives the wheels and/or inefficiencies in the type of rowing motion used to power the vehicle.

The present invention was developed to provide a more efficient row-vehicle that is capable of higher speeds than existing arm and leg powered vehicles.

It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### SUMMARY

According to a first aspect of the present invention there is provided an arm and leg powered vehicle comprising:

a chassis mounted on a plurality of wheels, at least one of said wheels being a drive wheel wherein rotation of the drive wheel propels the vehicle forward;

a seat mounted on the chassis for a rider to sit on, the seat being constrained against longitudinal movement relative to the chassis;

a handlebar operatively connected to a steering rod whereby axial rotation of the handlebar generates a turn on at least one of said wheels, the handlebar including a handle holder arranged to move in a linear reciprocating manner relative to the steering rod;

a foot pedal housing arranged to move in a linear reciprocating manner relative to a rail fixedly connected to the chassis; and,

a power transmission system for receiving power from the arms of the rider in response to the application of a pulling force to the handlebar and from the legs of the rider in response to the application of the pushing force to the foot pedal housing and transmission of the received power to the drive wheel;

characterized in that, when the arms and legs of the rider are used independently, the power transmission system transmits power from the arms or the legs of the rider, and when the arms and legs of the rider are used simultaneously, the power transmission system receives and transmits the sum of the power from the arms and the legs of the rider.

In one embodiment, the power transmission system is arranged to receive power from the legs of the rider at a fixed force delivery ratio relative to the power received from the arms of the rider, the fixed force delivery ratio being preferably 2:1 to take advantage of the natural tendency for the legs of a rider to be twice as strong as the arms of the rider. For a more experienced or more athletic rider, a lower fixed force delivery ratio can be used, preferably 1.5:1.

In a first embodiment, the power transmission system is arranged to receive power from the arms and/or legs of the rider during the drive stroke and the power transmission system runs on idle during the return stroke. In a second embodiment, the power transmission system is arranged to receive power from the arms of the rider during the return stroke in addition to the power received from the arms and legs of the rider during the drive stroke.

The handlebar may be telescopic in that the handlebar further comprises one or more nested sleeves arranged to slide in a linear reciprocating manner along the steering rod with the handle holder being arranged to slide in a linear reciprocating manner along the length of the sleeve. In this way the length of the handlebar increases during the drive stroke. The handlebar may further comprise a sleeve return spring biased to resist movement of the sleeve relative to the steering rod during the drive stroke and thus facilitate movement of the sleeve to a resting position during the return stroke. A first end of the sleeve return spring may be attached to the chassis and a second end of the sleeve return spring may be attached to the sleeve.

In one preferred embodiment the drive wheel is the rear wheel and axial rotation of the handlebar generates a turn on the front wheel.

In one embodiment, the power transmission system further comprises a drive cable arranged to travel around a plurality of pulleys, the drive cable having a first end fixedly attached to the handle holder and a second end fixedly attached to a drum. The power transmission system may further comprise a drive gear assembly arranged to deliver power from the drum to the drive wheel. At least one of the plurality of pulleys may be fixedly mounted on the foot pedal housing and constrained to move with the foot pedal housing along the rail.

Advantageously, the drum may further comprise a first reel and a second reel arranged in a side-by-side relationship, the first reel arranged to receive the drive cable whereby the drive cable is unwound from the first reel during the drive stoke and is rewound onto the first reel during the return stroke. A particular advantage is achieved when the width of the first reel is matched to the width of the drive cable such that the drive cable is wound onto the first reel of the drum in a single row. As the drive cable becomes unwound from the first reel of the drum, the drum operates in the same way as an automatic step down ratio.

The second reel of the drum may be arranged to receive an elastic tensioning means, the elastic tensioning means being stretched during the drive stroke so as to encourage rotation of the drum in the opposite direction during the return stroke. The elastic tensioning means is thus used to rewind the drive cable onto the first reel of the drum during the return stroke.

In one embodiment, the handle holder, the steering rod and/or one or more sleeves are of a shape and size to preclude axial rotation relative to each other, with each of the handle holder, the steering rod and/or the sleeve having a multilateral cross-section, preferably rectangular or square

Advantageously, the back rest of the seat may be arranged to tilt and move in a downwardly during the drive stroke in order to take advantage of the power that can be generated through the back muscles of rider. Accordingly, the seat may further comprise a base upon which the buttocks of the rider rest in use, a backrest for providing support to the back of the rider, the backrest provided with a tilting means comprising a plunger constrained to slide within a plunger housing to facilitate downward movement of the backrest during the drive stroke. The plunger may further comprise an elastic element to resist downward movement of the plunger within the plunger housing and thus move the plunger upward during the return stroke.

When the rider elects to power the vehicle using the arms or legs separately, the vehicle may further comprise a fixing means for restricting movement of the handle holder relative to the sleeve or for restricting movement of the foot pedal housing relative to the rail. In one embodiment, the fixing means comprises a frame with an aperture correspondingly shaped to receive the sleeve or the rail, and a lock arranged to engage with the sleeve or the rail.

The arm and leg powered vehicle may further comprise a braking system and/or a gear shifting system.

According to a second aspect of the present invention there is provided a power transmission system for the arm and leg powered vehicle according to the first aspect of the present invention.

### BRIEF DESCRIPTION OF THE DRAWINGS

In order to facilitate a more detailed understanding of the nature of the invention several embodiments of the arm and leg powered vehicle will now be described in detail, by way of example only, with reference to the accompanying drawings, in which:

FIG. 1 shows a side view of an arm and leg powered vehicle according to a first embodiment showing the position of the handles and foot pedals at the start of the drive stroke;

FIG. 2 shows a side view of an arm and leg powered vehicle according to a first embodiment showing the position of the handles and foot pedals at the end of the drive stroke;

FIG. 3a shows an embodiment of the power transmission system in which the ratio between forces applied to the foot pedal and handle is equal to 2;

FIG. 3b shows an embodiment of the power transmission system in which the ratio between forces applied to the foot pedal and handle is equal to 1.5.

FIG. 4 shows the position of the rider and the handles and foot pedals at the beginning of the drive stroke;

FIG. 5 shows the position of the rider and the handles and foot pedals at the end of the drive stroke;

FIG. 6a shows the position of the handlebar at the beginning of the drive stroke in the first embodiment;

FIG. 6b shows the position of the handlebar at the middle of the drive stroke in the first embodiment;

FIG. 6c shows the position of the handlebar at the end of the drive stroke in the first embodiment;

FIG. 6d shows a cross-sectional view of the handle holder, sleeve and steering rod of the handlebar taken along lines A-A as shown in FIG. 6c;

FIG. 6e shows a cross-sectional view of the steering rod bearing housing taken along lines B-B as shown in FIG. 6c;

FIG. 7 illustrates the position of the back rest of the seat at the start of the drive stroke;

FIG. 8 illustrates the position of the back rest of the seat at the end of the drive stroke;

FIGS. 9a and 9b illustrate an embodiment of the power transmission system that includes a drum with two reels for separate winding of the drive cable and the elastic tensioning means;

FIG. 10 illustrates a side view of a second embodiment of arm and leg powered vehicle showing the arrangement of the power transmission system at the start of the drive stroke;

FIG. 11 illustrates the arm and leg powered vehicle of FIG. 10 showing the arrangement of the power transmission system at the end of the drive stroke;

FIG. 12 is top view of the forward end of the steering rod of the arm and leg powered vehicle of FIGS. 10 and 11;

FIG. 13 shows a side view of an arm and leg powered vehicle according to a third embodiment showing the position of the handles and foot pedals at the start of the drive stroke;

FIG. 14 shows a side view of an arm and leg powered vehicle according to FIG. 13 showing the position of the handles and foot pedals at the end of the drive stroke;

FIG. 15a shows the position of the handlebar at the beginning of the drive stroke for the third embodiment;

FIG. 15b shows the position of the handlebar at the middle of the drive stroke for the third embodiment;

FIG. 15c shows the position of the handlebar at the end of the drive stroke for the third embodiment; and,

FIG. 15d shows one embodiment of the fixing means.

### DETAILED DESCRIPTION

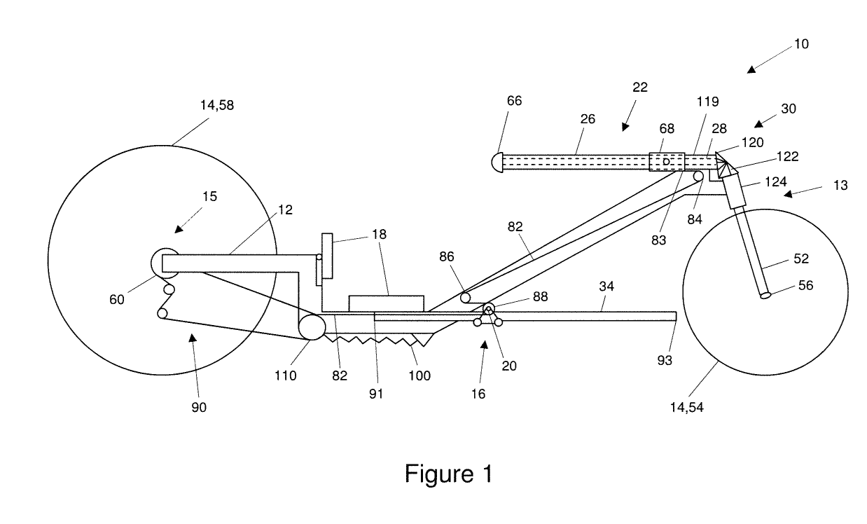

Specific embodiments of the present invention are now described in detail in the context of an arm and leg powered vehicle for use in transportation. It is to be understood that the present invention is equally applicable to an arm and leg powered vehicle adapted for use as a piece of exercise equipment. For the purpose of this discussion, it will be assumed that the vehicle has only one front wheel and one rear wheel. It is to be understood, however, that the vehicle could equally be provided with any number of front or rear wheels. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs. With reference to FIG. 1, the arm and leg powered vehicle 10 comprises a low elongate chassis 12 mounted on a plurality of wheels 14, a power transmission system 16 able to set in rotation at least one of said wheels 14, a seat 18 for the rider to sit on, a pair of foot pedals 20 for the rider's feet to rest on, and a handlebar 22 for the rider to hold onto and steer with whilst riding the vehicle 10. The elongate chassis 12 has a forward end 13 and a rearward end 15, the seat 18 being located towards the rearward end 15 and the handlebar 22 being located towards the forward end 13. The chassis 12 is elongated to accommodate the full range of movement of the rider during the sculling motion used when riding the vehicle.

The chassis 12 terminates at its forward end 13 in a steering fork 52. The front wheel 54 of the vehicle 10 rotates about a front wheel axle 56 which is fixedly mounted on the steering fork 52. In a similar manner, a rear wheel 58 is mounted on a rear wheel axle 60 at the rearward end 15 of the chassis 12. In the preferred embodiments, the front wheel 54 is steerable and the rear wheel 58 is caused to rotate in response to the power transmitted through the power transmission system 16 during the drive stroke as described in greater detail below.

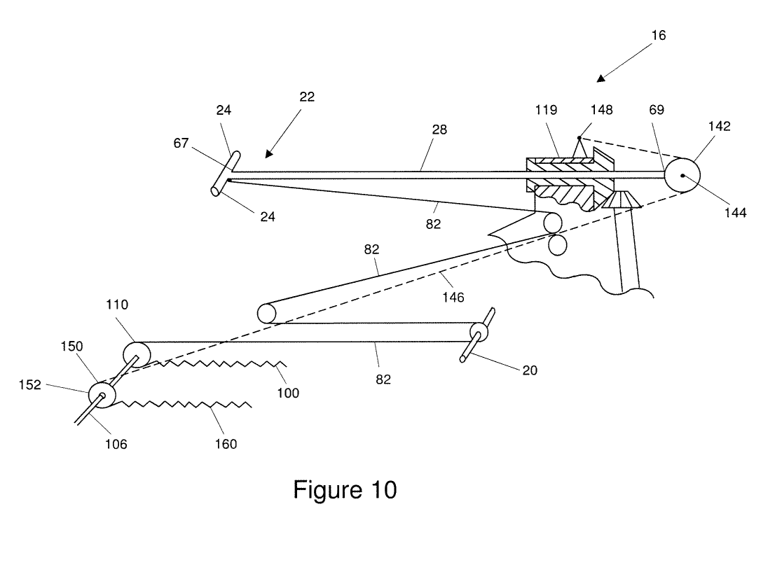

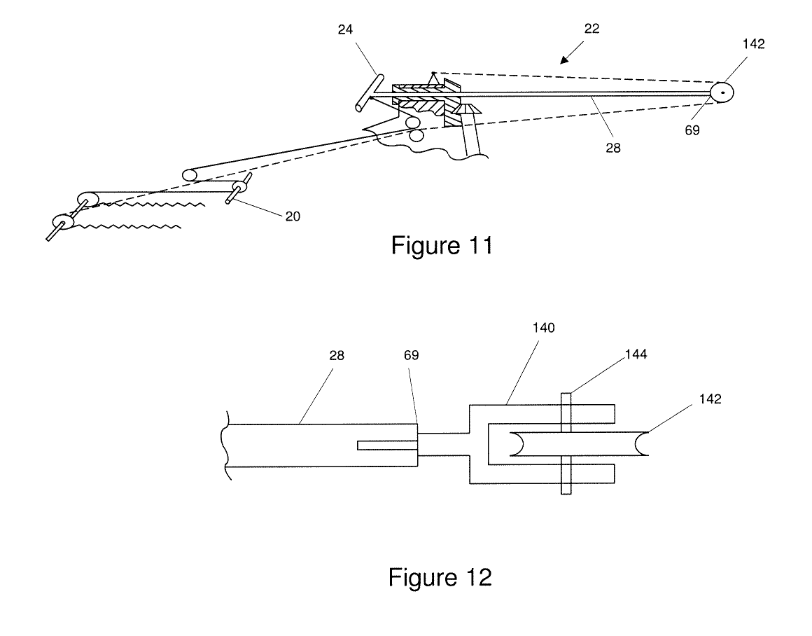

In general use, the rider uses his or her arms, legs and back to execute a linear reciprocating “rowing” motion which comprises a “drive” stroke followed by a return stroke. During the drive stroke, a pulling force is applied through the arms of the rider. At the same time, a pushing force is applied through the legs of the rider. During the return stroke, the rider either relaxes or applies a pushing force through their arms. The power transmission system 16 is arranged to receive power from the arms of the rider in response to the application of a pulling force to the handlebar and from the legs of the rider in response to the application of the pushing force to the foot pedal housing. Each of the arms and the legs can provide power to the power transmission system independently. However, the power transmission system of the present invention differs from those of the prior art in that when the arms and legs of the rider are used simultaneously, the power transmission system transmits the sum of the power from the arms and the legs of the rider to the drive wheel. In the first embodiment described below, the power transmission system 16 is arranged to run on idle during the return stroke. The manner in which this is achieved is apparent from the description to follow. In a second embodiment illustrated with reference to FIGS. 10 to 12, the power transmission system 16 is further arranged to receive power through the arms of the rider during return stroke as described in greater detail below.

The delivery of power from the legs and arms of the rider to the power transmission system 16 of the first embodiment is now described with reference to FIGS. 4 and 5 which illustrate the position of the rider, in which the foot pedals 20 and the handlebar 22 are positioned at the beginning and the end of pushing and pulling strokes, respectively. The foot pedals 20 are fixedly mounted to and extend outwardly from opposed sides of a foot pedal housing 32. The foot pedal housing 32 is arranged to slide in a linear reciprocating manner along a rail 34. The rail 34 extends towards the front of the vehicle 10 and terminates at its rearward end 91 at the portion of the chassis 12 adjacent to the seat 18. The rail 34 terminates at its forward end 93 adjacent to the front wheel 54. The length of the rail 34 is set as a function of the maximum anticipated length of travel of the foot pedal housing 32 along the rail 34 at the end of a given drive stroke which will depend in part on the length of the rider's legs.

At the start of the drive stroke, the rider assumes a crouched position in which his or her knees are bent and the rider places his or her feet on the foot pedals 20. At the start of the drive stroke, the foot pedal housing 32 is located towards the rearward end 91 of the rail 34 as illustrated in FIG. 4. During the drive stroke, the legs of the rider apply a pushing force on the foot pedals 20 causing the foot pedal housing 32 to slide forward along the rail 34 towards the front wheel 54. During the return stroke, the foot pedal housing 32 slides rearward along the rail 34 towards the seat 18. The foot pedals 20 may be provided with straps 95 or other suitable restraints to assist in maintaining contact between the feet of the rider and the foot pedals 20 during the return strokes in use.

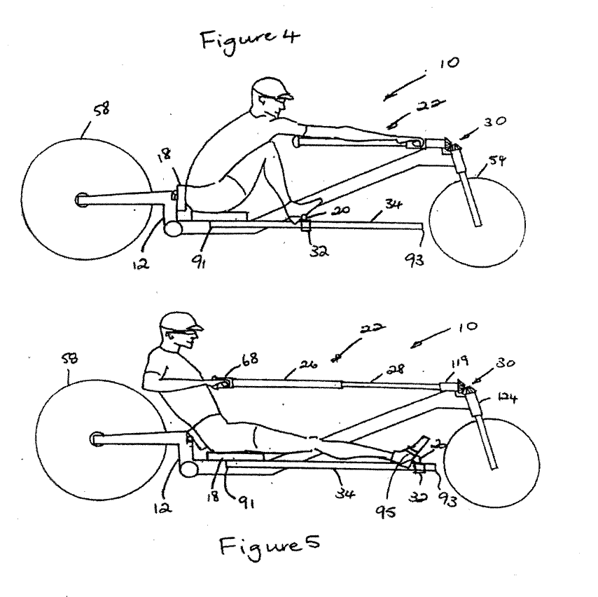

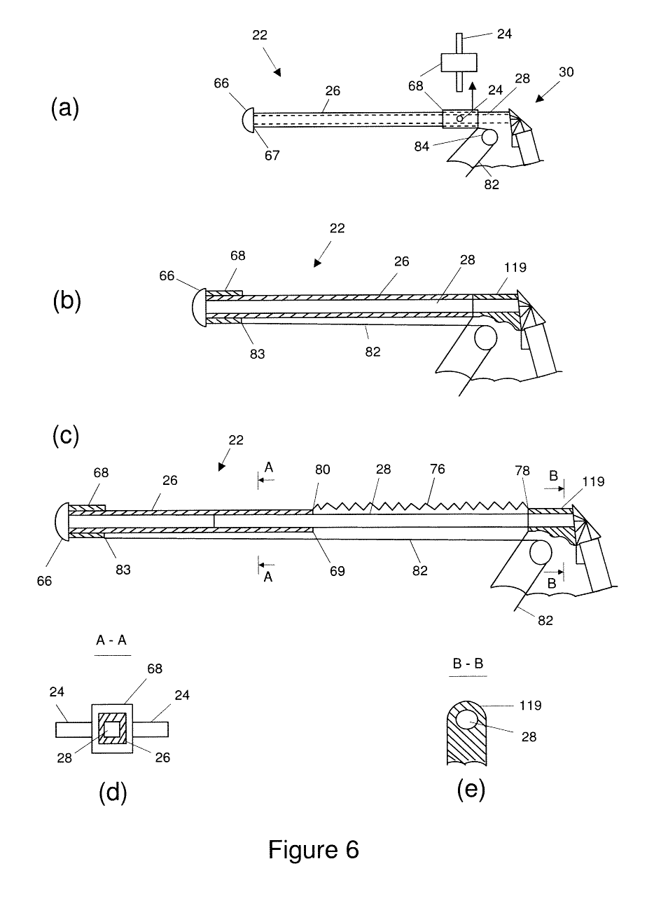

The delivery of power from the arms of the rider to the power transmission system 16 is now described with reference to FIGS. 6a, 6b and 6c which illustrate the position of handlebar 22 at the beginning, the middle and the end of pulling stroke, respectively. The handlebar 22 comprises a pair of handles 24 extending outwardly from opposed sides of and fixedly mounted to a handle holder 68. The handle holder 68 is constrained to slide in a linear reciprocating manner along the length of a sleeve 26 which is in turn arranged to slide in a liner reciprocating manner along the length of the steering rod 28. The steering rod 28 is operatively connected to a steering mechanism 30. It is to be understood that any number of sleeves 26 may be used but for the purposes of the discussion to follow, it will be assumed that the handlebar 22 includes only one such sleeve 26.

In use, the rider applies a pulling force to the handles 24 during each drive strokes. The pulling force of the arms of the rider upon the handles 24 is transmitted to the handle holder 68 which then slides rearward along the length of the sleeve 26 until it reaches a stop 66. The stop 66 is fixedly attached at the rearward end 67 of the sleeve 26. The stop 66 serves a dual function. Firstly, the stop 66 prevents the handle holder 68 from being pulled off the steering rod 28. Secondly, once the handle holder 68 has reached the stop 66, the application of a further pulling force during the drive stroke by the rider, causes rearward linear movement of the sleeve 26 along the steering rod 28. In this way, the handlebar 22 is telescopic in that its length is fully adjustable in response to the degree of pulling stroke applied by the rider.

The handlebar 22 further comprises a sleeve return spring 76 having a first end 78 attached to the chassis 12 at a suitable location and a second end 80 attached to the sleeve 26, preferably at the forward end 69 of the sleeve 26. During the drive stroke, the sleeve return spring 76 is stretched and stores elastic energy. During the return stroke, the elastic energy stored in the sleeve return spring 76 is released, encouraging movement of the sleeve 26 back along the steering rod 28 towards the front of the vehicle 10 in preparation for the next drive stroke.

The handles 24 and pedals 20 are operatively connected to the power transmission system 16 which transmits the sum of the power generated from the pulling and pushing forces applied through the arms and the legs of the rider to the rear wheel 58. The power transmission system 16 comprises a drive cable 82 of fixed length, an arrangement of pulleys 81, a drive cable drum 110 and drive gear assembly 90 arranged to cause forward rotation of the rear wheel 58 to propel the vehicle 10 forward. The drive gear assembly 90 may be any suitable combination of transmission chain and rear wheel gears, including conventional derailer and freewheel arrangements used for standard bicycles.

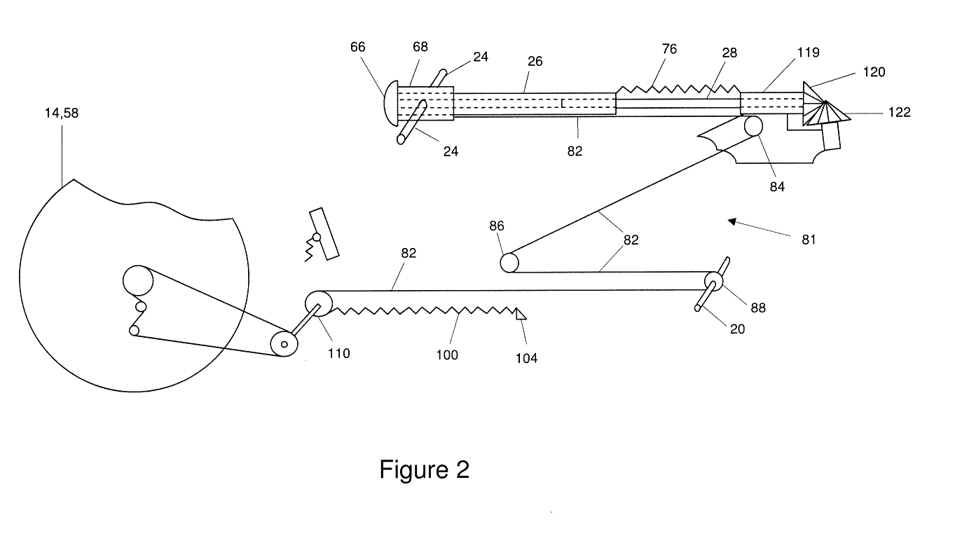

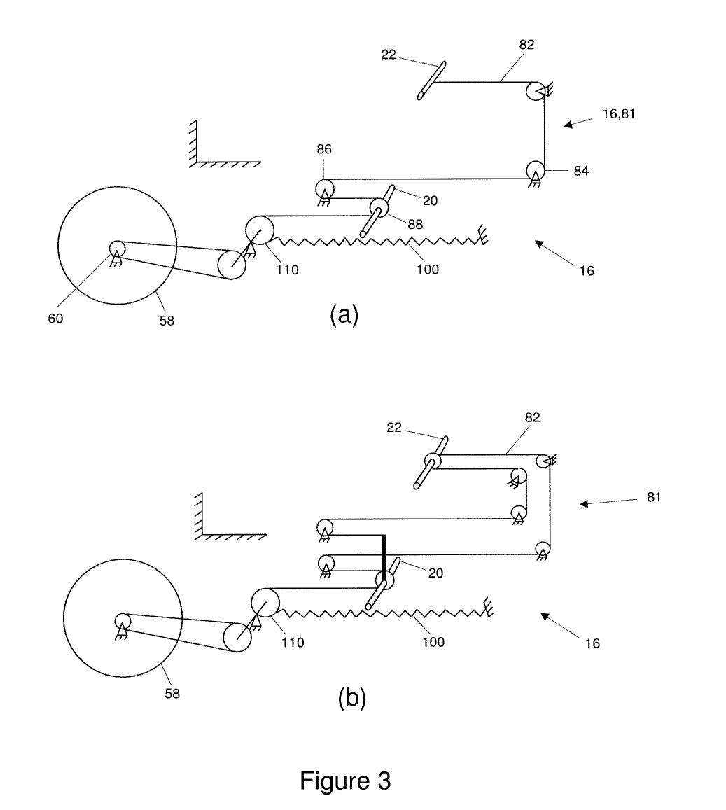

In FIGS. 1, 2 and 3a, the power transmission system 16 is arranged such that the force delivery ratio of the pushing force applied to the foot pedals 20 relative to the pulling force applied to the handles 24 is equal to 2. In this arrangement, if the length of travel of the foot pedal housing 32 relative to the rail 34 is equal to be length of travel of the handle holder 68 relative to the steering rod 28, the power delivered to the rear wheel 58 through the effort of the pushing force applied by the legs will be twice the power delivered to the rear wheel 58 through the effort of the pulling force being applied by the arms. In an alternative arrangement illustrated in FIG. 3b, the ratio of the pushing force applied to the foot pedals 20 relative to the pulling force applied to the handles 24 is equal to 1.5. In this arrangement, if the length of travel of the foot pedal housing 32 relative to the rail 34 is equal to be length of travel of the handle holder 68 relative to the steering rod 28, the power delivered to the rear wheel 58 through the effort of the pushing force applied by the legs will be one and a half times the power delivered to the rear wheel 58 through the effort of the pulling force being applied by the arms.

The force delivery ratio is in this way adjustable to suit the athleticism of the rider. When the length of the stroke for the arms and the legs are equal, the power delivery ratio is the same as the force delivery ratio. The particular force delivery ratios achieved using the embodiment of the power transmission system 16 illustrated in FIGS. 1, 2 and 3a was been selected on the basis of a realization by the Inventor that for a typical rider, their legs are able to deliver twice as much pushing force as the pulling force able to able to be delivered through their arms. A more experienced or more athletic rider who is able to utilize greater pulling force through their arms may be better suited to use the arm and leg power vehicle 10 with the force delivery ratio of the power transmission system 16 illustrated in FIG. 3b.

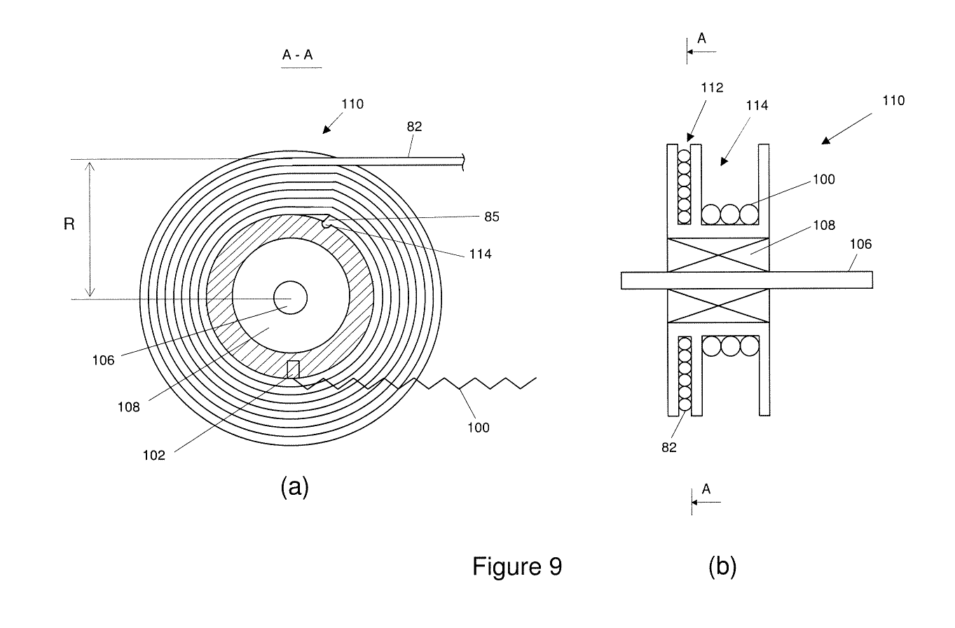

A first end 83 of the drive cable 82 is fixedly attached at to the handle holder 68 from where it extends over a first fixed pulley 84 positioned towards the forward end 13 of the chasses 12 adjacent to the steering mechanism 30. Thereafter the drive cable 82 extends rearward around a second fixed pulley 86 and then forward again around a third pulley 88 which is fixedly mounted to and travels with the foot pedal housing 32. The drive cable 82 loops around the third pulley 88 and from there extends rearward, terminating at its second end 85 at a drive cable drum 110 (best seen in FIG. 9).

The drive cable 82 is caused to travel the combined distance traveled by the handle holder 68 relative to the steering rod 28 and the foot pedal housing 32 relative to the rail 34. The power transmission system 16 is thus arranged in such a way that the simultaneous pulling with the arms in a linear reciprocating manner and pushing with the legs transmits the sum of the power generated by the two strokes directly to the rear wheel 58. At the same time the power transmission system 16 allows the rider to use their arms or their legs independently to deliver power to the rear wheel 58 of the vehicle 10.

In the embodiment illustrated in FIGS. 9a and 9b, the drive cable drum 110 is provided with a first and second reel, 112 and 114 respectively, arranged in a side-by-side relationship. The first reel 112 is arranged to receive the second end 85 of the drive cable 82 which is fixedly attached to the first reel 112 using any suitable fixing means 114, for example a simple screw. At the start of the drive stroke, the drive cable 82 is wound around the first reel 112 of the drive cable drum 110. When a pulling force is applied to the handles 24 and/or a pushing force is applied to the foot pedals 20, the drive cable 82 unwinds from first reel 112 causing the drive cable drum 110 to rotate in a first direction. During the return stroke, the drive cable 82 is rewound onto the first reel 112 as the drive cable drum 110 rotates in the opposite direction.

As best seen in FIG. 9b, the width of the first reel 112 is matched to the width of the drive cable 82 such the drive cable 82 is wound onto the first reel 112 in a single row. This arrangement is used so that the effective radius, R, of the drive cable drum 110 is greatest when the drive cable 82 is fully wound around the first reel 112 of the drive cable drum 110 at the start of the drive stroke. During the drive stroke, the effective diameter of the drive cable drum 110 reduces such that the drive cable drum 110 operates in an analogous manner as an automatic step-down ratio. This feature provides improved power transmission to the rear wheel 58 as it balances the natural differential acceleration that occurs during the drive stroke whilst rowing.

The second reel 114 of the drive cable drum 110 is arranged to receive a first elastic tensioning means 100. The first tensioning means 100 is wound around the second reel 114 of the drive cable drum 110 in the opposite direction to the direction in which the drive cable 82 is wound around the drive cable drum 110. A first end 102 of the first elastic tensioning means 100 is fixedly attached to the second reel 114 whilst the second end 104 of the first elastic tensioning means 100 is fixed to the chassis 12. During the drive stroke, when a pulling force is applied to the handles 24 and/or a pushing force is applied to the foot pedals 20, the drive cable drum 110 is cause to rotate in the first direction in response to the pull on the drive cable 82 as described above. As the drive cable drum 110 rotates, the first elastic tensioning means 100 becomes wound onto the second reel 114 of the drive cable drum 110 at the same time that the drive cable 82 is being unwound from first reel 112 of the drive cable drum 110.

The drive cable drum 110 rotates on an axle 106 in cooperation with a freewheel 108 which is arranged to deliver power to the rear wheel 58 during the drive stroke via the drive gear assembly 90. During the return stroke, the freewheel 108 allows the drive cable drum 110 to rotate in the opposite direction under the pull of the stretched first elastic tensioning means 100 without affecting the forward rotation of the rear wheel 58. During the return stroke, the drive cable 82 is rewound onto the first reel 112 of the drive cable drum 110 at the same time that the first elastic tensioning means 100 is being unwound from the second reel 114 of the drive cable drum 110.

The steering mechanism 30 is now described in detail with reference to FIGS. 1 and 6. The handlebar 22 is operatively connected to the steering mechanism 30 in such a way that an axial rotation of the handlebar 22 relative to the steering rod 28 generates a turn in the front wheel 54. The plane of the pulling force applied to the handlebar 22 for delivering power to the rear wheel 58 of the vehicle 10 and the plane of axial rotation of the handlebar 22 for steering the vehicle 10 are perpendicular to each other. The latter is important for the greater efficiency of the power delivery to the drive wheel 58.

The handle holder 68, the sleeve 26 and the steering rod 28 are of a shape and size to preclude axial rotation relative to each other. This is achieved in the illustrated embodiments by each of the handle holder 68, the sleeve 26 and the steering rod 28 having a multilateral cross-section, preferably rectangular or square as best seen in FIG. 6d. When an axial turning force is applied to the handle holder 68 by the rider, the axial rotation is transferred through the steering rod 28 to the steering mechanism 30. With reference to FIG. 1, the steering mechanism 30 comprises an arrangement of bevel gears 62. An upper bevel gear 120 is mounted to the steering rod 28 using a suitable steering rod bearing housing 119. A lower bevel gear 122 is mounted to the steering fork 52 in a similar fashion using a suitable steering fork bearing housing 124 in the manner of a standard bicycle. The steering operation may be performed at any time.

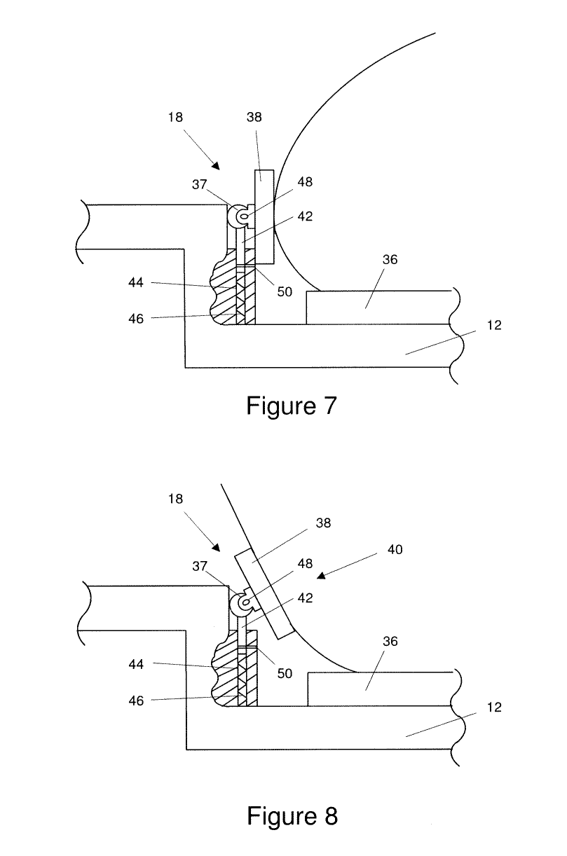

The arm and leg powered vehicle 10 also includes a unique seat 18 which further contributes to the efficiency of power transmission by utilizing their back muscles of the rider to lengthen the drive stroke. The seat 18 comprises a base 36 upon which the buttocks of the rider rest in use, and a back rest 38 for providing support to the back of the rider in use. FIGS. 7 and 8 illustrate the position of the back rest 38 at the beginning and the end of the drive stroke, respectively. The back rest 38 is important to successful operation of the vehicle 10. Many prior art arm and leg powered vehicles rely on a back rest of fixed rigid construction but the Inventor has realized that this arrangement restricts full movement of the rider at the end of each drive stroke.

The back rest 38 includes a tilting means 40 arranged to allow the back rest 38 to move downwards as it tilts. The tilting means 40 comprises a plunger 42 constrained to slide within a plunger housing 44. During each drive stroke, the horizontal part of the force applied from the back of the rider on the back rest 38 is transmitted to the chassis 12 through a bearing mounted to an axis of a hinge 48. Towards the end of the stroke, depending on the movement of the rider's back, the force applied to the back rest 38 of the seat 18 causes downward sliding of the plunger 42 within the plunger housing 44 depressing an elastic element 46, for example a simple helical spring. The elastic element 46 serves the function of storing potential energy which is released during the return stroke, causing the plunger 42 to slide upwardly within the plunger housing 44 to its original position. The back rest 38 is fixed to the plunger 42 by way of the hinge 48, the result being that, as the plunger 42 slides downwardly within the plunger housing 44, the back rest 38 can tilt. The plunger housing 44 includes a boss 50 to control the maximum allowable travel of the plunger 42 within the plunger housing 44. It is readily apparent from FIGS. 7 and 8 that the movement of the back rest 38 provides for a more efficient distribution of the power applied to the pedal, handle and back rest during the full drive stroke as it allows fuller backward movement of the body of the rower to extend his drive stroke.

The vehicle 10 further includes a braking system (not shown) which may be arranged to apply braking force to the rear wheel 58 and/or the front wheel 54. The vehicle 10 may further include a gear shifting system of the type known in the art of standard bicycles or other types of vehicles.

A second embodiment of the power transmission system of the present invention is illustrated in FIGS. 10 to 12 in which like reference numerals refer to like parts. In this embodiment, the power transmission system 16 is arranged to deliver power from the arms of the rider to the rear wheel 58 during the drive stroke and the return stroke. To achieve this, the handlebar 22 is no longer telescopic but fixed in length. The handles 24 are fixedly mounted to and extend outwardly from opposing sides of the rearward end 67 of the steering rod 28. The steering rod 28 terminates at its forward end 69 in a fork 140 arranged to allow rotation of a fourth pulley 142 about the fourth pulley axle 144 as best seen in FIG. 12. The role of the fork 140 is to allow rotation of the steering rod 28 in response to axial rotation of the handlebar 22 when the rider wants to make a turn whilst at the same time maintaining the fourth pulley 140 in an upright position. This is done to ensure that the power transmission system 16 continues to operate whilst turning.

In this second embodiment, the power transmission system 16 further comprises a return stroke drive cable 146 having a first end 148 fixedly attached to the steering rod bearing housing 119 and a second end 150 attached to a return stroke cable drum 152. The return stroke cable drum 152 is fixed to the same axle 106 as the drive cable drum 110. The return stroke drive cable 146 is looped around the fourth pulley 142 such that forward movement of the steering rod 28 during the return stroke results in forward movement of the fourth pulley 142 thereby pulling the return stroke drive cable 146 through the same distance.

FIG. 10 illustrates the arrangement of power transmission system 16 at the start of the return stroke. When the rider applies a pushing force with their arms to the handles 24, this force causes forward movement of the steering rod 28 and concomitant forward movement of the fourth pulley 142. As a result, the return stroke drive cable 146 is unwound from the return stroke cable drum 152 transmitting power to cause forward rotation of the rear wheel 58 to propel the vehicle 10 forward. The power transmission system 16 further comprises a second elastic tensioning means 160 which operates in an analogous manner to the first elastic tensioning means 100 to rewind the return stroke cable 146 onto the return stroke cable drum 152 during the drive stroke.

Now that the preferred embodiments of the present invention have been described in detail, the present invention has a number of advantages over the prior art, including the following:
a) the vehicle requires a minimum of parts;
b) the vehicle is easy to operate and provides exercise to the arms, leg and back;
c) the linear reciprocating movement of the arms and legs is more convenient and more power efficient than existing prior art arrangements;
d) the full range of motion of the arms, legs and back is provided;
e) the complete utilization of power produced by different strength capacity of the legs and arms is provided;
f) power may be transmitted through the independent or combined action of the arm and the legs; and,
g) The rider is able to relax during the return stroke by resting his arms on the stiff (in vertical direction) handle bar.

It will be apparent to persons skilled in the relevant art that numerous variations and modifications can be made without departing from the basic inventive concepts. For example, the arm and leg powered vehicle may be readily adapted for use indoors as a piece of exercise equipment by mounted the drive wheel (typically the rear wheel) over one or a pair of rotatable rollers to stop forward motion of the vehicle. Furthermore, an auxiliary motor such as an internal combustion engine, may be connected to the drive mechanism to assist in travelling up a steep slope.

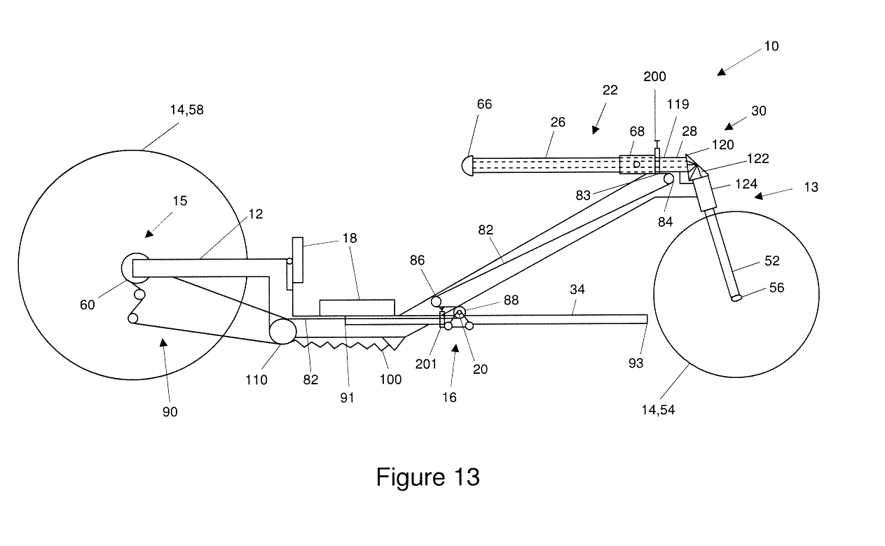

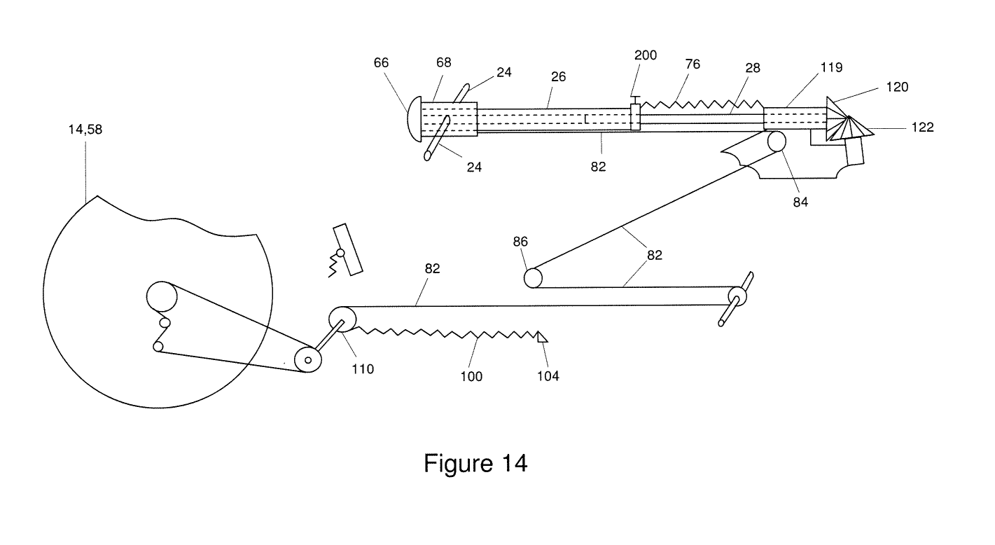

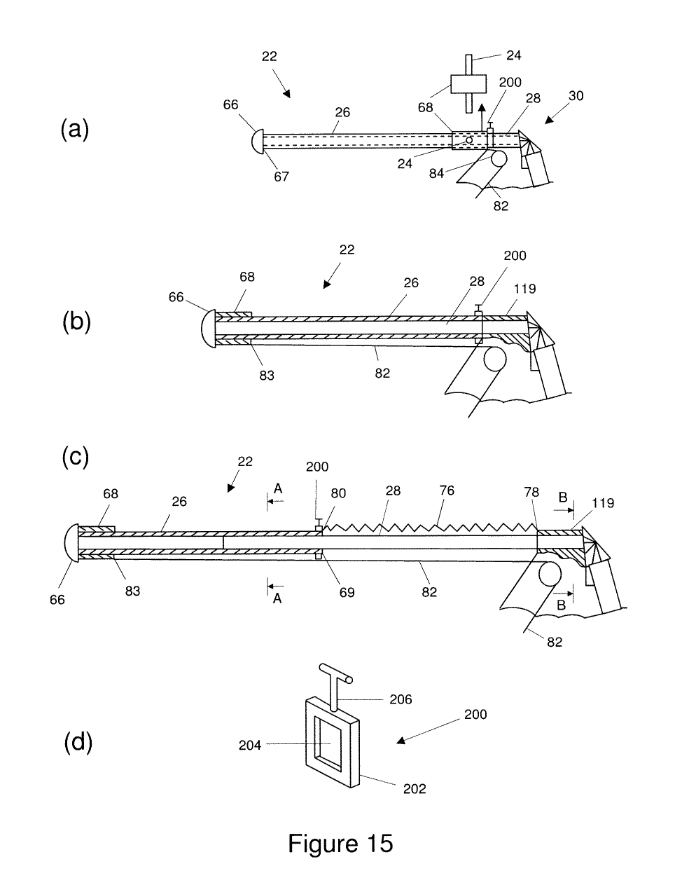

In a third embodiment of the present invention illustrated in FIGS. 13 to 15 for which like reference numerals refer to like parts. In this embodiment, the vehicle 10 is fitted with one or more fixing means 200 for restricting movement of the handle holder 68 relative to the sleeve 26 or for restricting movement of the foot pedal housing 32 relative to the rail 34. With reference to FIG. 15, the fixing means 200 comprises a frame 202 with an aperture 204 correspondingly shaped to receive the sleeve 26 or the rail 34, and a lock, in this example a simple screw, 206 arranged to engage with the sleeve 26 or the rail 34. The fixing means 200 is used to increase the efficiency of power utilization when the rider elects to use the arms or legs separately.

For example, if the rider elects to use only his or her legs to power the vehicle 10, the fixing means 200 is locked into position along the length of the sleeve 26, at a location which provides the rider with a relaxing position for resting their arms and back muscles. In this scenario, the fixing means 200 is fitted to the vehicle 10 by inserting the sleeve 26 through the aperture 204 of the fixing means 200. When the rider has decided on a comfortable location to secure the fixing means 200, the fixing means 200 is locked into position relative to the sleeve 26 by causing the lock 206 to engage the sleeve 26 with sufficient force to resist the pulling force that is applied through the drive cable 82 to the handle holder 68 when the rider applies a pushing force to the foot pedal housing 32 using his or her legs.

If on the other hand, the rider elects to use only his or her arms to power the vehicle 10, the fixing means 200 is locked into position at a location along the length of the rail 34 which provides the rider with a relaxing position for resting their legs. In use, the rail 34 is inserted through the aperture 204 of the fixing means 200 and the fixing means 200 is locked into position relative to the rail 34 by causing the lock 206 to engage the rail 34 with sufficient force to resist the pulling force that is applied through the drive cable 82 to the foot pedal housing 32 when the rider applies a pulling force to the handle holder 68 using his or her arms.

All such modifications and variations are considered to be within the scope of the present invention, the nature of which is to be determined from the foregoing description and the appended claims.

What is claimed:

1. An arm and leg powered vehicle comprising:
a chassis mounted on a plurality of wheels, at least one of said wheels being a drive wheel wherein rotation of the drive wheel propels the vehicle forward;
a seat mounted on the chassis for a rider to sit on, the seat being constrained against longitudinal movement relative to the chassis;
a handlebar operatively connected to a steering rod whereby axial rotation of the handlebar generates a turn on at least one of said wheels, the handlebar including a handle holder arranged to move in a linear reciprocating manner relative to the steering rod;
a foot pedal housing arranged to move in a linear reciprocating manner relative to a rail fixedly connected to the chassis; and,
a power transmission system for receiving power from the arms of the rider in response to the application of at least one of a pulling force to the handlebar and a pushing force to the handlebar, and the power transmission system is further configured to receive power from the legs of the rider in response to the application of the pushing force to the foot pedal housing and transmission of the received power to the drive wheel;
wherein:
when the arms and legs of the rider are used independently, the power transmission system receives power from the arms or the legs of the rider, and when the arms and legs of the rider are used simultaneously, the power transmission system receives and transmits the sum of the power from the arms and the legs of the rider;
the power transmission system is arranged to receive power from the legs of the rider at a fixed force delivery ratio of 2:1 relative to the power received from the arms of the ride; and
the drive mechanism is arranged to receive power from the arms of the rider during the return stroke in addition to the power received from the arms and legs of the rider during the drive stroke.

2. The arm and leg powered vehicle of claim 1, wherein the handlebar further comprises one or more nested sleeves arranged to slide in a linear reciprocating manner along the steering rod with the handle holder being arranged to slide in a linear reciprocating manner along the length of a or the sleeve.

3. The arm and leg powered vehicle of claim 2, wherein the handlebar further comprises a sleeve return spring biased to resist movement of a or the sleeve relative to the steering rod during the drive stroke and thus facilitate movement of a or the sleeve to a resting position during the return stroke.

4. The arm and leg powered vehicle of claim 3, wherein a first end of the sleeve return spring is attached to the chassis and a second end of the sleeve return spring may be attached to the sleeve.

5. The arm and leg powered vehicle of claim 1, wherein the drive wheel comprises a rear wheel of the vehicle and axial rotation of the handlebar generates a turn of a front wheel of the vehicle.

6. The arm and leg powered vehicle of claim 1, wherein the power transmission system further comprises a drive cable arranged to travel around a plurality of pulleys, the drive cable having a first end fixedly attached to the handle holder and a second end fixedly attached to a drum, the power transmission system further comprising a drive gear assembly arranged to deliver power from the drum to the drive wheel.

7. The arm and leg powered vehicle of claim 6, wherein at least one of the plurality of pulleys is fixedly mounted on the foot pedal housing and constrained to move with the foot pedal housing along the rail.

8. The arm and leg powered vehicle of claim 6, wherein the drum comprises a first reel and a second reel arranged in a side-by-side relationship, the first reel arranged to receive the drive cable whereby the drive cable is unwound from the first reel during the drive stoke and is rewound onto the first reel during the return stroke.

9. The arm and leg powered vehicle of claim 8, wherein the width of the first reel is matched to the width of the drive cable such that the drive cable is wound onto the first reel of the drum in a single row.

10. The arm and leg powered vehicle of claim 9, wherein the drum operates as an automatic step down ratio.

11. The arm and leg powered vehicle of claim 8, wherein the second reel of the drum is arranged to receive an elastic tensioning means, the elastic tensioning means being stretched during the drive stroke so as to encourage rotation of the drum in the opposite direction during the return stroke.

12. The arm and leg powered vehicle of claim 2, wherein the handle holder, the steering rod and/or one or more sleeves are of a shape and size to preclude axial rotation relative to each other.

13. The arm and leg powered vehicle of claim 12, wherein each of the handle holder, the steering rod and/or the sleeve have a multilateral cross-section.

14. The arm and leg powered vehicle of claim 13, wherein the multilateral cross-section is rectangular or square.

15. The arm and leg powered vehicle of claim 1, wherein the seat is arranged to tilt and move in a downward direction during the drive stroke.

16. The arm and leg powered vehicle of claim 1, wherein the seat further comprises a base upon which the buttocks of the rider rest in use, a backrest for providing support to the back of the rider, the backrest provided with a tilting means comprising a plunger constrained to slide within a plunger housing to facilitate downward movement of the backrest during the drive stroke.

17. The arm and leg powered vehicle of claim 1, wherein the plunger further comprises an elastic element to resist downward movement of the plunger within the plunger housing and thus move the plunger upward during the return stroke.

18. The arm and leg powered vehicle of claim 1, further comprising a fixing means for restricting movement of the handle holder relative to the sleeve or for restricting movement of the foot pedal housing relative to the rail when the rider elects to power the vehicle using the arms or legs separately.

19. The arm and leg powered vehicle of claim 18, wherein the fixing means comprises a frame with an aperture correspondingly shaped to receive the sleeve or the rail, and a lock arranged to engage with the sleeve or the rail.

20. The arm and leg powered vehicle of claim 1, further comprising a braking system and/or a gear shifting system.
